(19) United States
(12) Patent Application Publication
(10) Pub. No.: US 2017/0067545 A1
(43) Pub. Date: Mar. 9, 2017

(54) CHAIN TENSIONER

(71) Applicant: BorgWarner Inc., Auburn Hills, MI (US)

(72) Inventors: Enrico ZECCARA, Arcore (IT); Roberto MERELLI, Monza (IT)

(73) Assignee: BorgWarner Inc., Auburn Hills, MI (US)

(21) Appl. No.: 15/118,542

(22) PCT Filed: Feb. 21, 2014
(86) PCT No.: PCT/US14/17711

§ 371 Date: Aug. 12, 2016

(51) Int. Cl. F16H 7/08; F01L 1/047; F16H 7/18; F16H 57/05; F16H 57/04

(52) U.S. Cl. CPC F16H 7/08; F16H 57/05; F16H 57/0471; F16H 57/0424; F16H 7/18; F01L 1/047; F16H 2007/0806; F16H 2007/0842; F16H 2007/0872; F16H 2007/0891; F16H 2007/0895; F16H 2007/0878; F16H 2007/0859; F16H 2007/0812; F01L 2001/0476

(57) ABSTRACT

A number of variations may include a product including a tensioner for a vehicle engine chain comprising a piston housing body portion having a piston bore formed therein for slideably receiving a piston connected to a chain guide shoe, and a camshaft bearing support or a combustion engine cylinder block or an engine cylinder head, extending from the body portion.

### TECHNICAL FIELD

The field to which the disclosure generally relates to includes tensioners and assemblies including the same for a vehicle engine chain drive.

### BACKGROUND

Tensioners may be used to tighten and/or guide vehicle engine chains.

### SUMMARY OF ILLUSTRATIVE VARIATIONS

A number of variations may include a product including a tensioner for a vehicle engine chain comprising a piston housing body portion having a piston bore formed therein for slideably receiving a piston connected to a chain guide shoe, and a camshaft bearing support or a combustion engine cylinder block, or engine cylinder head, extending from the body portion.

In a number of variations, the piston housing body portion is integrated in the camshaft bearing support wherein the body and the camshaft bearing support are a single continuous piece and may have a uniform crystal structure or uniform polymeric content.

In a number of variations, the body and the combustion engine cylinder block, or engine cylinder head, are integrated as a single piece of continuous metal having uniform crystal structure and without separate interface boundaries.

A number of variations may include a tensioner having a piston housing body portion having a piston bore formed therein, a piston slideably received in the piston bore, a chain guide shoe attached to the piston, the chain guide shoe having a surface for engaging a vehicle engine chain, and having a tab with a through-hole formed therein, and a locked pin extending through the tab to hold the tensioner in a retracted position.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view of a product including a tensioner according to a number of variations.

FIG. 2 is a perspective view of the tensioner of FIG. 1 attached to a lower camshaft bearing support according to a number of variations.

FIG. 3 is a perspective illustration of a tensioner as shown in FIG. 1 and including a chain engaged by the tensioner according to a number of variations.

FIG. 4 is an end view of the product shown in FIG. 3.

FIG. 5 is a perspective view with portions removed of the tensioner shown in FIG. 1.

FIG. 6 is a sectional view of a tensioner according to a number of variations.

FIG. 7 is a perspective view of a tensioner having a chain guide shoe received on a piston and moveable in a downward direction according to a number of variations.

FIG. 8 is a perspective view of a tensioner as shown in FIG. 7 connected to a lower camshaft bearing support according to a number of variations.

FIG. 9 is a perspective view of a tensioner as shown in FIG. 7 and further including a chain engaged by the tensioner according to a number of variations.

FIG. 10 is an end view of the product shown in FIG. 9.

FIG. 11 is a perspective sectional view of a tensioner according to a number of variations.

FIG. 12 is a sectional view of a tensioner according to a number of variations.

FIG. 13 is a perspective view of a tensioner piston housing integrated into the engine block according to a number of variations.

### DETAILED DESCRIPTION OF ILLUSTRATIVE VARIATIONS

The following description of the variations is merely illustrative in nature and is in no way intended to limit the scope of the invention, its application, or uses.

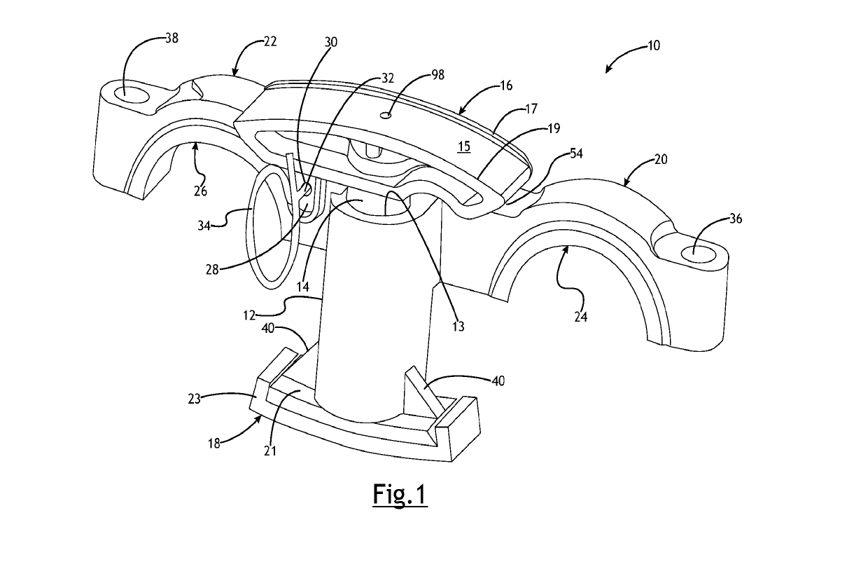

FIG. 1 illustrates a number of variations which may include a product 10 including a tensioner having a piston housing body portion 12 having a piston bore 13 formed therein for slideably receiving a piston 14. A first chain guide shoe 16 may be attached to one end of the piston 14 and may include a chain engagement surface 15 which may have an arc shape. At least a first lip 17 and/or a second lip 19 may be provided to laterally restrain a chain moving over the chain engagement surface 15. A second guide shoe 18 may be provided and connected to one end of the piston housing body portion 12 or made an integral part thereof. The second shoe 18 may include an inner arc shaped portion 21 and an outer arc shaped portion 23 overlying the same. The outer arc shaped portion 23 may include first and second spaced apart lips and a chain engagement surface similar to lips 17, 19 and chain engagement surface 15 of the first chain guide shoe 16. The second chain guide shoe 18 may be fixed with respect to the piston housing body portion 12.

In a number of variations, a first camshaft bearing support 20 may extend from the piston housing body portion 12. A second camshaft bearing support 22 may also extend from the piston housing body portion 12. In a number of variations, the piston housing body portion 12, first camshaft bearing support 20 and second camshaft bearing support 22 are a single piece integrated in a continuous component made from a continuous polymer material or a continuous metal having a uniform crystalline structure. Alternatively, the piston housing body portion 12, first camshaft bearing support 20 and second camshaft bearing support 22 may be individual components that are connected together by bolts, screws or other fastening devices.

The first camshaft bearing support 20 may include a recess 24 which may be arc shaped, semicircular or otherwise constructed and arranged to receive a camshaft. Bearings may be received in the first camshaft bearing support 20 to facilitate rotation of a camshaft in the recess 24. The first camshaft bearing support 20 may include at least a first through-hole 36 and/or a third through-hole 54 each for receiving a bolt to secure the first camshaft support to a cylinder surface of a combustion engine block, or engine cylinder head, or to a lower camshaft bearing support. Similarly, the second camshaft bearing support 22 may have a recess 26 formed therein which may be arc shaped, semicircular or otherwise constructed to receive a camshaft therein. Bearings may be received in the second camshaft support 22 to facilitate rotation of a camshaft in the recess 26. A second through-hole 38 and/or a fourth through-hole 56 may be formed in the second camshaft support 22 so that the second camshaft 22 may be bolted to a cylinder surface of an engine cylinder block or a lower camshaft support as will be described hereafter.

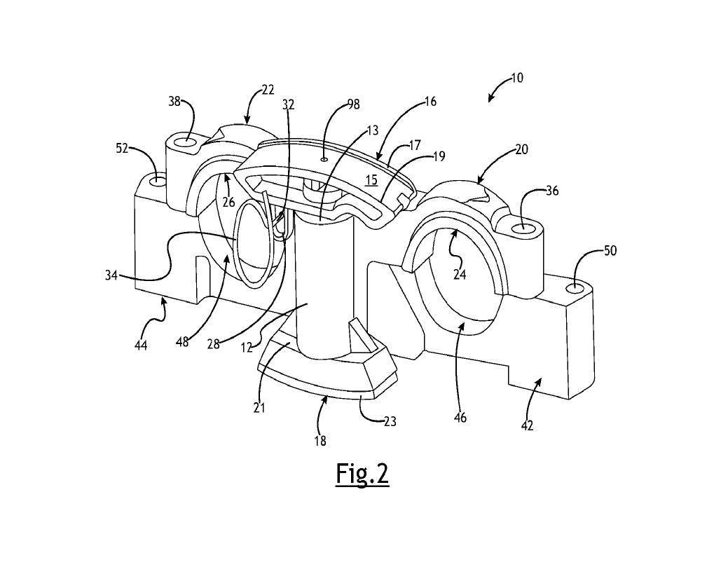

FIG. 2 illustrates a number of variations. In a number of variations, a tensioner 10 as shown in FIG. 1 may be coupled to a first lower camshaft bearing support 42 and/or a second camshaft bearing support 44. In a number of variations, the first lower camshaft bearing support 42 and second lower camshaft bearing support 44 may be in the form of an engine cylinder block or engine cylinder head. The first camshaft bearing support 42 may include a recess 46 formed therein which may be arc shaped, semicircular or otherwise configured and arranged to receive a portion of a camshaft therein and may be aligned with the recess 24 formed in the first camshaft support 20. The first lower camshaft bearing support 42 may have first a recess 46 formed therein which may be threaded to receive a bolt extending through the through-hole 36 formed in the first camshaft bearing support 20. Bearings may be received in the first lower camshaft bearing support to facilitate rotation of a camshaft in the recess 46. In a number of variations, a through-hole 50 may be formed in the first lower camshaft bearing support 42 to facilitate bolting the first cams lower camshaft bearing support 42 to an engine block or to an engine cylinder head.

The second lower camshaft bearing support 44 may have a second recess 48 formed therein which may be arc shaped, semicircular or otherwise constructed and arranged to receive a portion of a camshaft therein. Bearings may be received in the second lower camshaft bearing support 44 to facilitate rotation of a camshaft in the recess 48. The second lower camshaft support 44 may have a recess formed therein which may be threaded to receive a bolt extending through the through-hole 38 in the second camshaft support 22. In a number of variations, a through-hole 52 may be formed in the second lower camshaft bearing support to facilitate a bolt extending therethrough to bolt the second lower camshaft bearing support 44 to an engine block. As will be appreciated from FIGS. 1 and 2, the piston bore hole 13, and the through-holes 36, 38 formed in each of the first camshaft bearing support 20 and second camshaft bearing support 22 may run parallel to each other to facilitate attachment of the first camshaft bearing support 20 and the second camshaft bearing support 22 to the upper or top cylinder surface of an engine block or to a lower camshaft support structure.

As will be appreciated from FIG. 2, in one variation the tensioner may be constructed so that the first chain guide shoe 16 is moveably biased in an upward direction away from the lower camshaft supports 42, 44 and/or a combustion engine block, or an engine cylinder head, on which the tensioner is fastened.

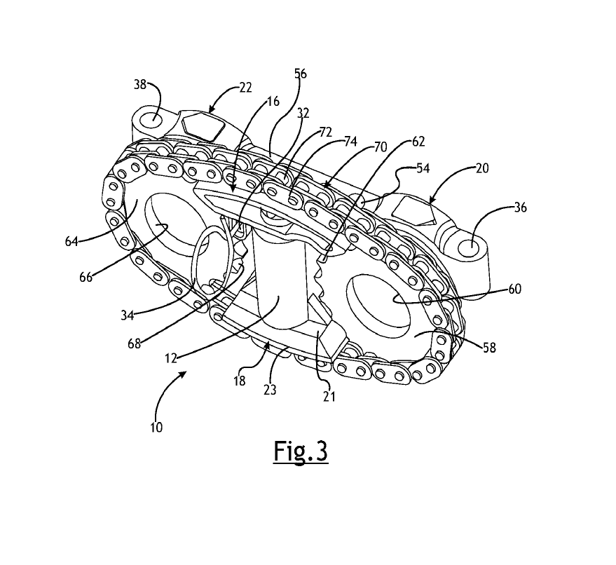

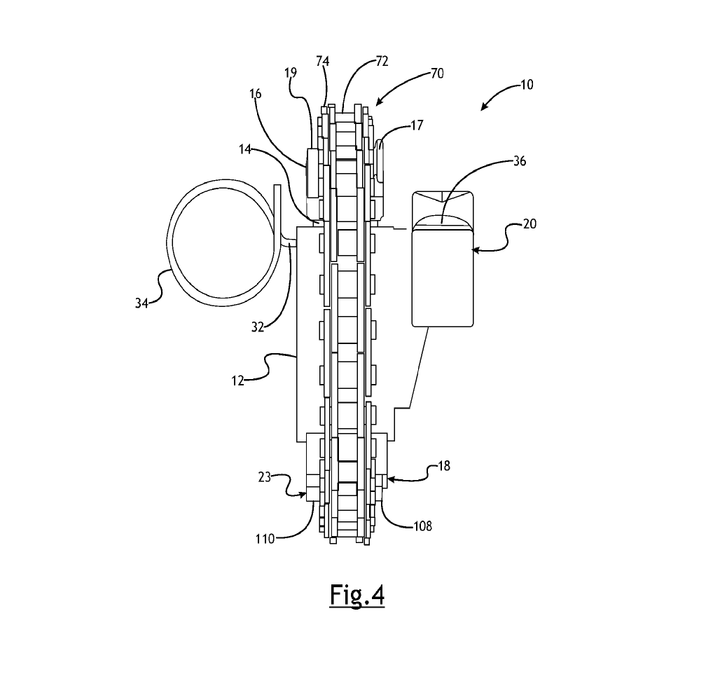

FIG. 3 illustrates a number of variations wherein the tensioner shown in FIG. 1 is provided with the chain guide shoe 16 locked in a retracted position by locked pin 32, which may include a finger grip portion 34 which may be a full or partial ring. The locked pin 32 may be inserted in a recess formed in one of the first camshaft bearing support 20 or second camshaft bearing support 22. The tensioner 10 may be positioned between a first sprocket 58 having a shaft bore 60 formed therein and having a plurality of teeth 62 on an outer edge thereof, and a second sprocket 64 having a shaft bore 66 formed therein and having a plurality of teeth 68 formed at an outer edge thereof. Associated camshafts may be received in each of the bore 60 of the first sprocket 58 and the bore 66 of the second sprocket 64. A chain 70 including a plurality of pin 72 and links 74 may be placed over each of the first sprocket 58 and second sprocket 64. The chain 70 may be easily positioned because the first chain guide shoe 16 is locked in a retracted position wherein the tensioner 10 does not place any biasing force on the chain 70. FIG. 4 is an end view of the product shown in FIG. 3.

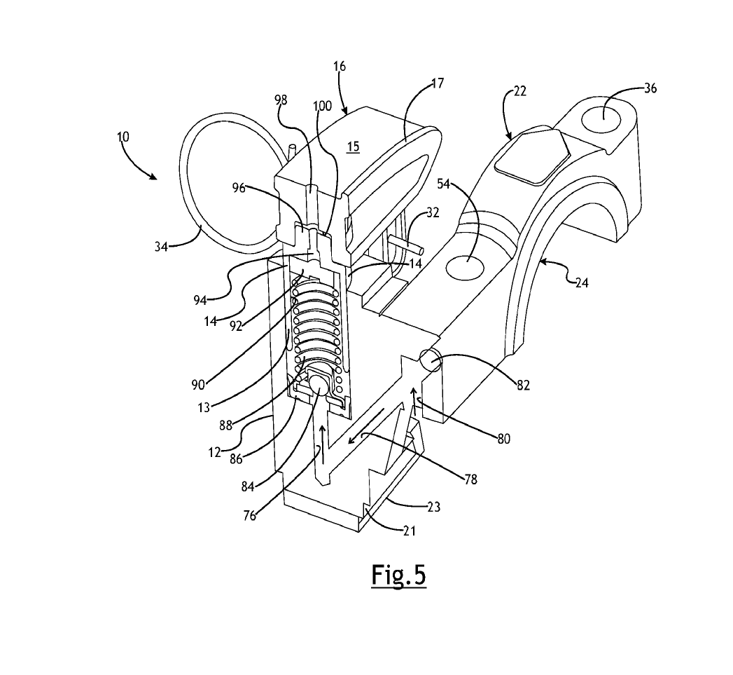

FIG. 5 illustrates a number of variations which may include a piston 14 which may have an inner bore 90. A spring 88 may be partially received in the inner bore 90 of the piston 14. In a number of variations, a first seat 86 may be positioned at the bottom of the inner bore 90 and the spring 88 may be positioned over the first seat 86. The first seat 86 may have a through hole formed therein and a check valve 84 may be position over the first oil channel 76 and/or the through hole in the first seat 84 to prevent oil from flowing out of the piston bore 13. A second seat 92 may be provided at the upper end of the bore 90 and may be engaged by the spring 88. The second seat 92 may have a through-hole formed therein or may be constructed and arranged to allow oil to flow around the second seat 92 and into a piston oil channel 94 extending through the head 96 of the piston 14. The piston head 96 may engage the piston engagement surface 100 on the first chain guide shoe 16. The first chain guide shoe 16 may have an oil channel 98 formed therein communicating with the oil channel 94 of the piston 14. A first oil channel 76 may be provided in the piston housing body portion 12 and may be formed parallel to and communicating with the piston bore 13. A second oil channel 78 may be provided and may extend through one of the first camshaft bearing support 20 or second camshaft bearing support 22 and into the piston housing body portion 12 to communicate with the first oil channel 76. The second oil channel 78 may be formed at an acute angle to the first oil channel 76. A third oil channel 80 may be formed in one of the first camshaft bearing support 20 or second camshaft bearing support 22 and communicates with the second oil channel 78. The third oil channel 80 may be formed at an acute angle to the second oil channel 78 and may be parallel to the first oil channel 76. A plug 82 may be provided in a first end of the second oil channel 78 to prevent oil from flowing out the first end of the second oil channel 78. The third oil channel 80 may communicate with an oil channel formed in a combustion engine block or an engine cylinder head. As will be appreciated from FIG. 5, in a number of variations, oil from a combustion engine cylinder block, or an engine cylinder head, may be provided and flow through an oil path, which may include the third oil channel 80, second oil channel 78, first oil channel 76, the piston bore 13, the oil channel 94 in the head of the piston 14 and the oil channel 98 formed in the first chain guide shoe 16 to provide oil to the chain engagement surface 15 and the chain 70.

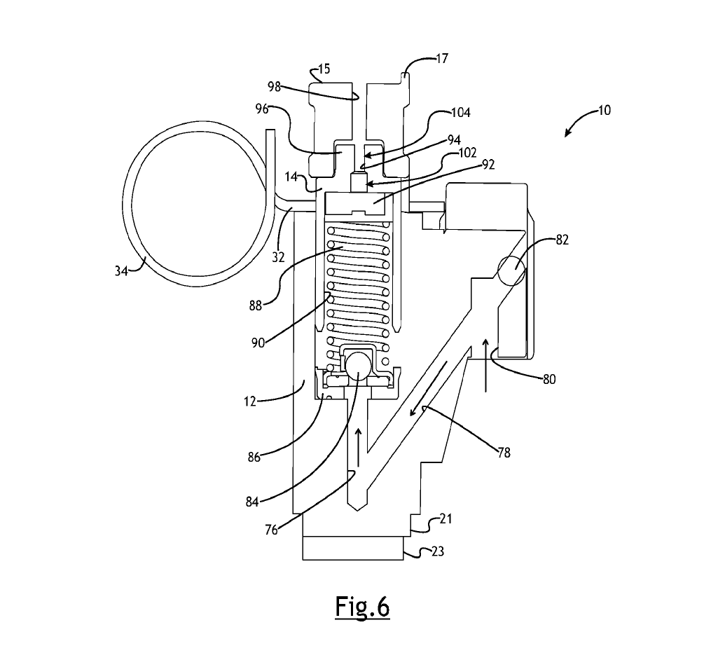

FIG. 6 is a section view of the product 10 shown in FIG. 5. In a number of variations, the oil channel 94 through the head 96 of the piston 14 may include a wider lower portion 102 and a narrower upper portion 104.

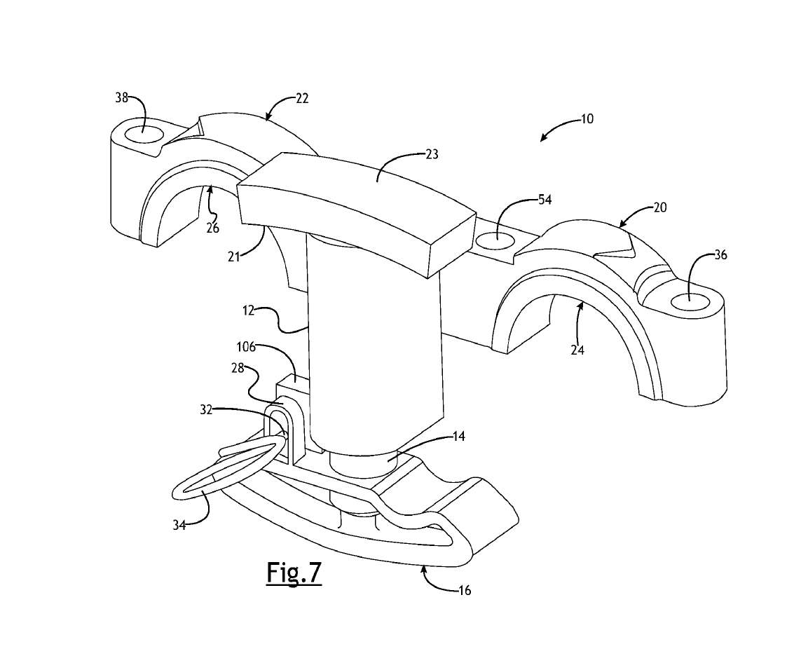

FIG. 7 illustrates a number of variations which may include a product 10 including a tensioner having a flange 106 extending from the piston housing body portion 12. The locked pin 32 may extend through a through hole 30 on the tab 28 and into a recess formed in the flange 106 to lock the chain guide shoe 16 in a retracted position to allow the chain 70 to be easily positioned over the tensioner.

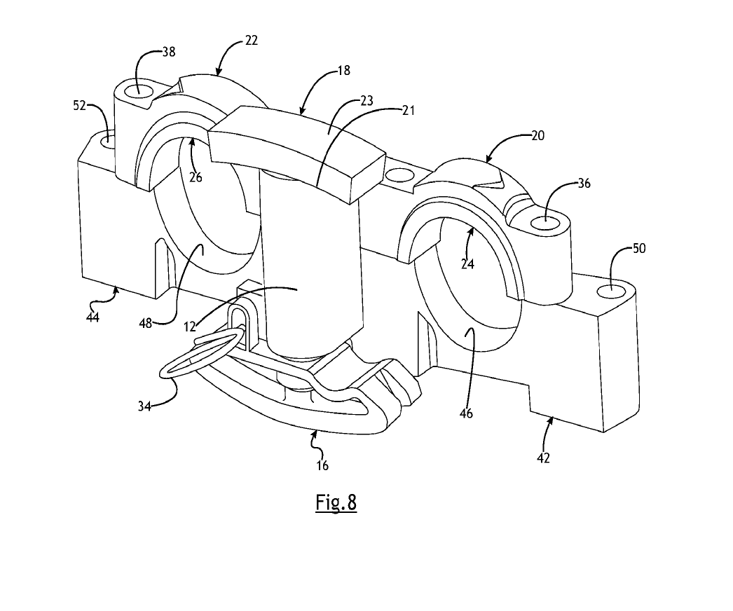

As shown in FIG. 8, in a number of variations, the tensioner shown in FIG. 7 may be connected to a first lower camshaft bearing support 42 and/or second lower camshaft bearing support 44 in a manner as described with respect to the above description of FIG. 2.

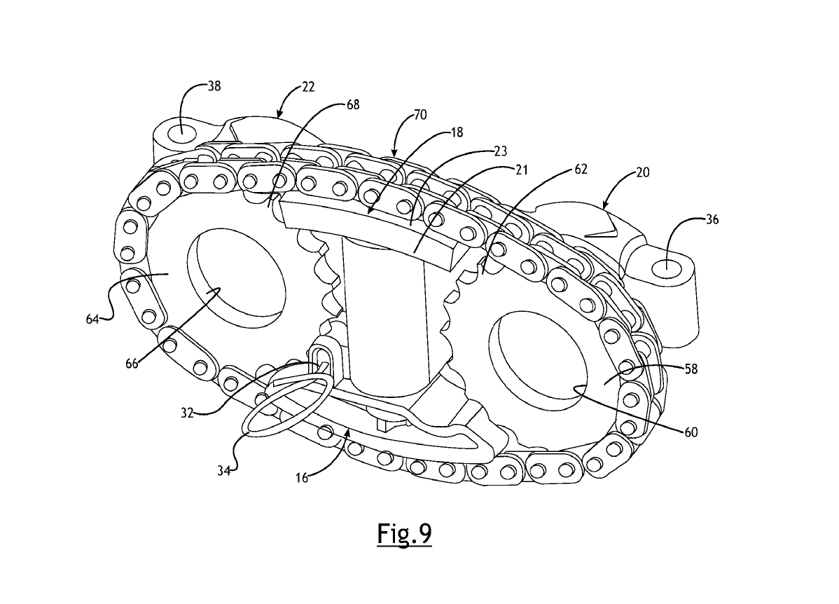

As illustrated in FIG. 9, in a number of variations the tensioner illustrated in FIG. 7 may be positioned between first and second sprockets 58 and 64 and a chain 70 may be placed over the sprockets while the first chain guide shoe 16 is locked in a retracted position so that the tensioner does not place a biasing force on the chain 70. Once the chain 70 is properly positioned, the locked pin 32 may be removed and the spring associated with the piston of the tensioner may apply a force to the piston 12 and chain guide shoe 16 which in turn applies a force to the chain 70.

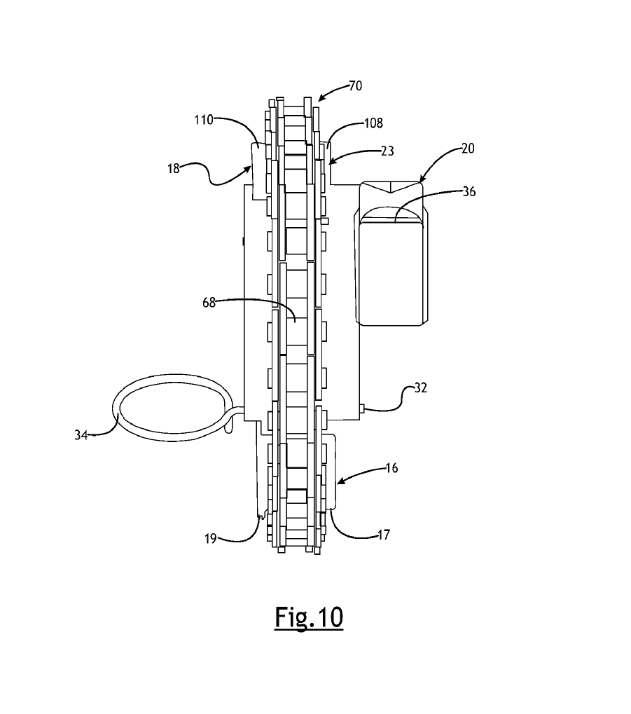

FIG. 10 is an end view of the assembly shown in FIG. 9. In a number of variations, the outer portion of the second chain guide shoe 18 may include spaced apart first and second lips 110, 108 for guiding the chain as it travels across the stationary second guide shoe 18.

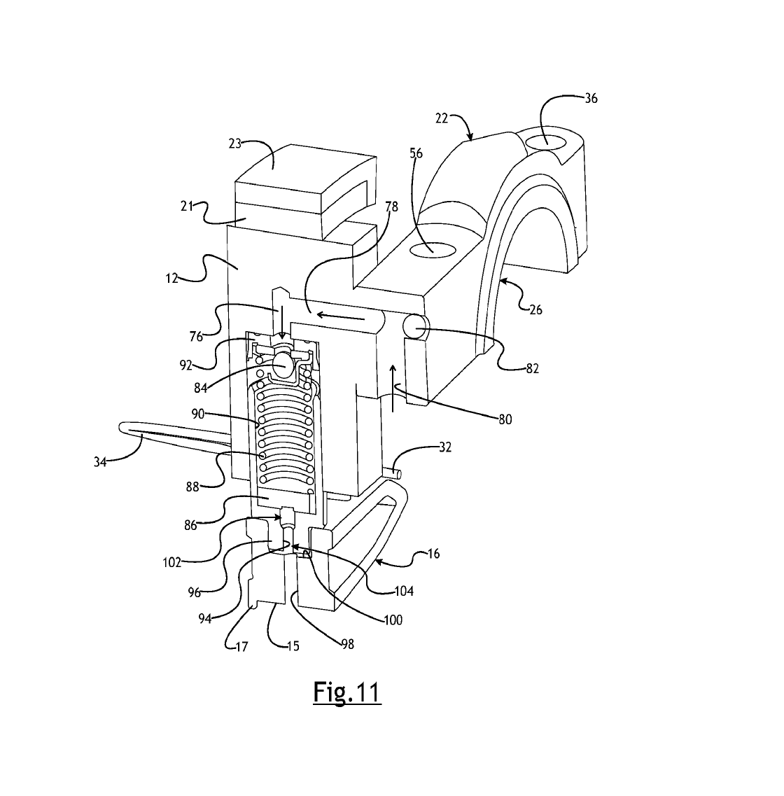

Referring now to FIG. 11, in a number of variations, a first oil channel 76 may be formed in the piston housing body portion 12 communicating with the piston bore 90 and being formed parallel thereto. A second oil channel 78 may be formed through one of the first upper camshaft bearing supports 20 and/or 22 and through the piston housing body portion 12 to communicate with the first oil channel 76. The second oil channel 78 may be formed at a right angle to the first oil channel 76. A third oil channel 80 may be formed in one of the first or second upper camshaft bearing supports 20, 22 to communicate with the second oil channel 78. The third oil channel 80 may be formed at a right angle to the second oil channel 78 and may be parallel to the first oil channel 76. A plug 82 may be placed at the end of the second oil channel 78 to prevent oil from flowing out of the second oil channel 78. The third oil channel 80 may be positioned to communicate with an oil channel in an engine block, or an engine cylinder head, to provide an oil path through the first and/or second upper camshaft bearing supports 20, 22, through the piston housing body portion 12, through the piston 14, and through moveable guide shoe 16 to provide oil to the chain engagement surface 15 and to the chain 70.

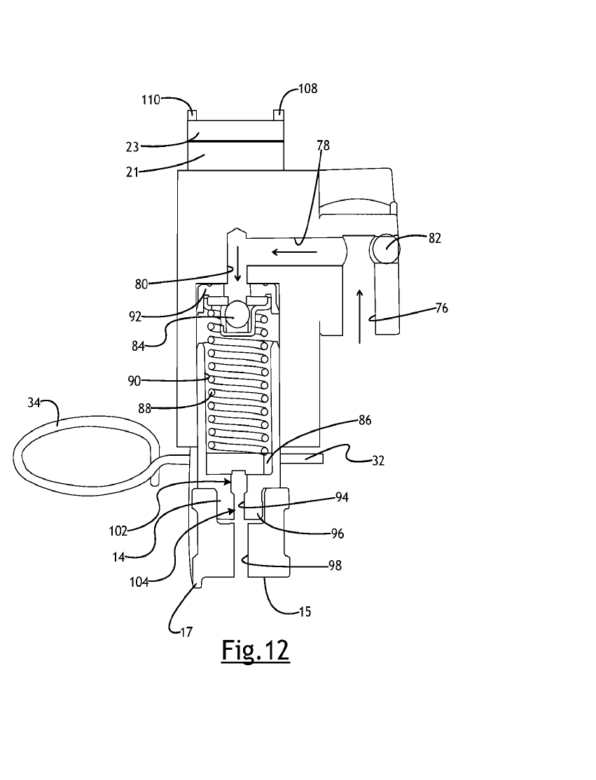

FIG. 12 is a section view of the product shown in FIG. 11. In a number of variations, the oil channel 94 through the head of the piston 14 may include a wider upper portion 102 and a narrower lower portion 104.

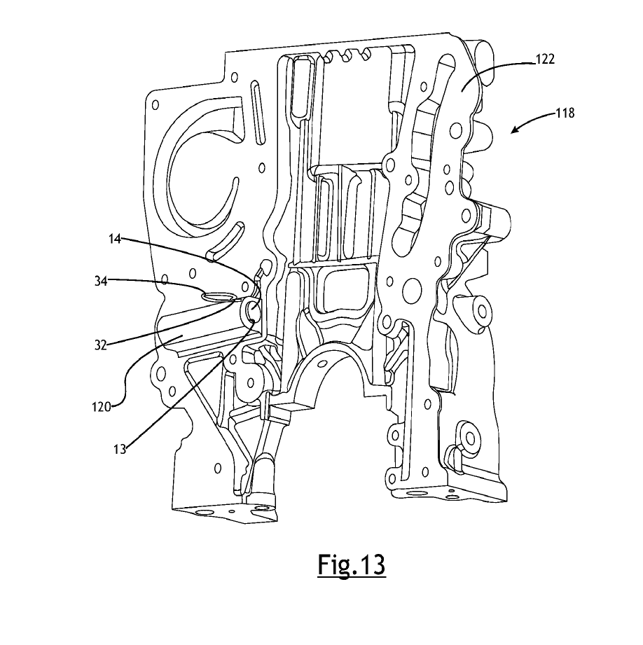

FIG. 13 illustrates a number of variations which may include a product 118 including a tensioner piston housing 120 integrated into an engine block 122. The tensioner piston housing 120 may include a piston bore 13 formed therein for slideably receiving a piston 14. In a number of variations, the tensioner piston housing 120 integrated into the engine block 122 may be a single continuous piece and may have a uniform crystal structure or uniform polymeric content. A piston 14 may be inserted into the tensioner piston housing 120 and may be locked in a retracted position by a locked pin 32, which may include a finger grip portion 34 which may be a full or partial ring. The locked pin 32 may be inserted into a recess formed in the tensioner piston housing 120. A chain guide shoe may be attached to one end of the piston 14 in a manner as described above.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising a tensioner for a vehicle engine chain comprising: a piston housing body portion having a piston bore formed therein constructed and arranged to slideably receive a piston therein; a first upper camshaft bearing support extending from the piston housing body portion, the first upper camshaft bearing support having a first recess formed therein constructed and arranged to receive a portion of a first camshaft for rotation therein.

Variation 2 may include a product as set forth in Variation 1 wherein the first upper camshaft bearing support has a first through hole formed therein.

Variation 3 may include a product as set forth in Variation 2 wherein the piston bore and the first through hole in the first upper camshaft bearing support are parallel.

Variation 4 may include a product as set forth in Variation 3 and further comprising a combustion engine having an upper cylinder head surface, and a bolt extending though the first through hole in the first upper camshaft bearing support and received in a threaded recess formed in the upper cylinder head surface.

Variation 5 may include a product as set forth in any of Variations 1-4 wherein the first upper camshaft bearing support includes a second recess formed therein constructed and arranged to receive a portion of a second camshaft for rotation therein.

Variation 6 may include a product as set forth in any of Variations 1-5 wherein the piston housing body portion and the first upper camshaft bearing support is a continuous single piece.

Variation 7 may include a product as set forth in any of Variations 1-6 further comprising a second upper camshaft bearing support extending from the piston housing body portion, the second upper camshaft bearing support having a second recess formed therein constructed and arranged to receive a portion of a second camshaft for rotation therein.

Variation 8 may include a product as set forth in Variation 7 wherein the second upper camshaft bearing support includes a first through hole form therein, and wherein the piston bore and the second through hole in the second upper camshaft bearing support are parallel.

Variation 9 may include a product as set forth in any of Variations 1-8 further comprising a piston and a spring received in the piston bore, a chain guide shoe attached to the piston, the chain guide shoe having a tab and a through hole formed in the tab, a locking pin received in the through hole of the tab to lock the chain guide shoe in a retracted position.

Variation 10 may include a product as set forth in any of Variations 1-9 and further comprising a piston and a spring received in the piston bore, a first chain guide shoe attached to the piston, the first chain guide shoe having a chain engagement surface, an oil path formed through the piston housing body portion, the first upper camshaft bearing support and the first chain guide shoe to provide oil to the chain engagement surface.

Variation 11 may include a product as set forth in Variation 10 wherein the oil path includes a first oil channel formed in the piston housing body and communicating with the piston bore, a second oil channel formed in the first upper camshaft bearing support and the piston housing body portion and communicating with the first oil channel, and a third oil channel formed in the first upper camshaft bearing support and communicating with the second oil channel, and a plug in the first end of the second oil channel to prevent oil from flowing out of the first end of the second oil channel.

Variation 12 may include a product as set forth in Variation 11 wherein the first oil channel is parallel to the piston bore.

Variation 13 may include a product as set forth in any of Variations 11-12 wherein the second oil channel is formed at an acute angle to the first oil channel.

Variation 14 may include a product as set forth in any of Variations 11-12 wherein the second oil channel is formed at a right angle to the first oil channel.

Variation 15 may include a product as set forth in any of Variations 1-14 and further comprising a first lower bearing support having a first recess formed therein constructed and arranged to receive a portion of the first camshaft for rotation therein, and wherein the piston is biased in an upward direction by the spring.

Variation 16 may include a product as set forth in any of Variations 1-15 and further comprising a first lower bearing support having a first recess formed therein constructed and arranged to receive a portion of the first camshaft for rotation therein, and wherein the piston is biased in a downward direction by the spring.

Variation 17 may include a product as set forth in Variation 16 wherein the first lower camshaft bearing support is an engine cylinder block or an engine cylinder head.

Variation 18 may include a product comprising: a tensioner for a vehicle engine chain comprising a piston housing body portion having a piston bore formed therein constructed and arranged to slideably receive a piston therein; a camshaft bearing support extending from the piston housing body portion, the first upper camshaft bearing support having a first recess formed therein constructed and arranged to receive a portion of a camshaft for rotation therein.

Variation 19 may include a product as set forth in Variation 18 wherein the piston housing body portion and the camshaft bearing support is a single contiguous piece.

Variation 20 may include a product as set forth in any of Variations 1-19 wherein the camshaft bearing support comprises an engine cylinder block or an engine cylinder head.

Variation 21 may include a product comprising a tensioner for a vehicle engine chain comprising: a tensioner piston housing integrated into an engine block, wherein the tensioner piston housing comprises a piston bore formed therein constructed and arranged to slideably receive a piston therein and wherein the tensioner piston housing and the engine block are a single continuous piece having a uniform crystal structure or uniform polymeric content.

Variation 22 may include a product as set forth in Variation 21 further comprising a piston and a spring received in the piston bore, a chain guide shoe attached to the piston, the chain guide shoe having a tab and a through hole formed in the tab, a locking pin received in the through hole of the tab to lock the chain guide shoe in a retracted position.

The above description of select variations within the scope of the invention is merely illustrative in nature and, thus, variations or variants thereof are not to be regarded as a departure from the spirit and scope of the invention.

What is claimed is:

1. A product comprising a tensioner for a vehicle engine chain comprising:
a piston housing body portion having a piston bore formed therein constructed and arranged to slideably receive a piston therein;
a first upper camshaft bearing support extending from the piston housing body portion, the first upper camshaft bearing support having a first recess formed therein constructed and arranged to receive a portion of a first camshaft for rotation therein.

2. A product as set forth in claim 1 wherein the first upper camshaft bearing support has a first through hole form therein.

3. A product as set forth in claim 2 wherein the piston bore and the first through hole in the first upper camshaft bearing support are parallel.

4. A product as set forth in claim 3 further comprising a combustion engine having an upper cylinder head surface, and a bolt extending though the first through hole in the first upper camshaft bearing support and received in a threaded recess formed in the upper cylinder head surface.

5. A product as set forth in claim 1 wherein the first upper camshaft bearing support includes a second recess formed therein constructed and arranged to receive a portion of a second camshaft for rotation therein.

6. A product as set forth in claim 1 wherein the piston housing body portion and the first upper camshaft bearing support is a continuous single piece.

7. A product as set forth in claim 3 further comprising a second upper camshaft bearing support extending from the piston housing body portion, the second upper camshaft bearing support having a second recess formed therein constructed and arranged to receive a portion of a second camshaft for rotation therein.

8. A product as set forth in claim 7 wherein the second upper camshaft bearing support includes a first through hole form therein, and wherein the piston bore and the second through hole in the second upper camshaft bearing support are parallel.

9. A product as set forth in claim 1 further comprising a piston and a spring received in the piston bore, a chain guide shoe attached to the piston, the chain guide shoe having a tab and a through hole formed in the tab, a locking pin received in the through hole of the tab to lock the chain guide shoe in a retracted position.

10. A product as set forth in claim 1 further comprising a piston and a spring received in the piston bore, a first chain guide shoe attached to the piston, the first chain guide shoe having a chain engagement surface, an oil path formed through the piston housing body portion, the first upper camshaft bearing support and the first chain guide shoe to provide oil to the chain engagement surface.

11. A product as set forth in claim 10 wherein the oil path includes a first oil channel formed in the piston housing body and communicating with the piston bore, a second oil channel formed in the first upper camshaft bearing support and the piston housing body portion and communicating with the first oil channel, and a third oil channel formed in the first upper camshaft bearing support and communicating with the second oil channel, and a plug in the first end of the second oil channel to prevent oil from flowing out of the first end of the second oil channel.

12. A product as set forth in claim 10 wherein the first oil channel is parallel to the piston bore.

13. A product as set forth in claim 12 wherein the second oil channel is formed at an acute angle to the first oil channel.

14. A product as set forth in claim 12 wherein the second oil channel is formed at a right angle to the first oil channel.

15. A product as set forth in claim 1 further comprising a first lower bearing support having a first recess formed therein constructed and arranged to receive a portion of the first camshaft for rotation therein, and wherein the piston is biased in an upward direction by the spring.

16. A product as set forth in claim 1 further comprising a first lower bearing support having a first recess formed therein constructed and arranged to receive a portion of the first camshaft for rotation therein, and wherein the piston is biased in a downward direction by the spring.

17. A product as set forth in claim 15 wherein the first lower camshaft bearing support is an engine cylinder block or an engine cylinder head.

18. A product comprising:
a tensioner for a vehicle chain comprising a piston housing body portion having a piston bore formed therein constructed and arranged to slideably receive a piston therein;
a camshaft bearing support extending from the piston housing body portion, the first upper camshaft bearing support having a first recess formed therein constructed and arranged to receive a portion of a camshaft for rotation therein.

19. A product as set forth in claim 18 wherein the piston housing body portion and the camshaft bearing support is a single contiguous piece.

20. A product as set forth in claim 19 wherein the camshaft bearing support comprises an engine cylinder block or an engine cylinder head.

21. A product comprising a tensioner for a vehicle engine chain comprising:
a tensioner piston housing integrated into an engine block, wherein the tensioner piston housing comprises a piston bore formed therein constructed and arranged to slideably receive a piston therein and wherein the tensioner piston housing and the engine block are a single continuous piece having a uniform crystal structure or uniform polymeric content.

22. The product of claim 21 further comprising a piston and a spring received in the piston bore, a chain guide shoe attached to the piston, the chain guide shoe having a tab and a through hole formed in the tab, a locking pin received in the through hole of the tab to lock the chain guide shoe in a retracted position.
